(19) United States
(12) Patent Application Publication
(10) Pub. No.: US 2025/0086355 A1
(43) Pub. Date: Mar. 13, 2025

(54) TRAIN CRASH ENERGY MANAGEMENT (CEM) OPTIMIZATION METHOD BASED ON MACHINE LEARNING

(71) Applicant: Southwest Jiaotong University, Chengdu (CN)

(72) Inventors: Lin JING, Chengdu (CN); Shaodong ZHENG, Chengdu (CN); Kai LIU, Chengdu (CN); Xiongfei ZHOU, Chengdu (CN); Kaiyun WANG, Chengdu (CN)

(73) Assignee: Southwest Jiaotong University, Chengdu (CN)

(21) Appl. No.: 18/677,996

(22) Filed: May 30, 2024

(30) Foreign Application Priority Data
Sep. 11, 2023 (CN) 2023111666301

(51) Int. Cl. G06F 30/23; G06F 119/14

(52) U.S. Cl. CPC G06F 30/23; G06F 2119/14

(57) ABSTRACT

A train crash energy management (CEM) optimization method based on machine learning is provided. The method includes: establishing a finite element model that is for an eight-marshalling train crash and considers a train energy absorption subsystem and a wheel-rail rolling contact behavior; establishing a machine learning database for train crash energy absorption; constructing a machine learning prediction model for the train crash energy absorption; and performing multi-objective optimization on CEM of a train based on machine learning.

### CROSS-REFERENCE TO THE RELATED APPLICATIONS

This application is based upon and claims priority to Chinese Patent Application No. 202311166630.1, filed on Sep. 11, 2023, the entire contents of which are incorporated herein by reference.

### TECHNICAL FIELD

The present disclosure relates to the technical field of passive safety in rail vehicle crashes, and in particular, to a train crash energy management (CEM) optimization method based on machine learning.

### BACKGROUND

As the operating velocity of trains continually increases, there are stricter requirements for safety and reliability of trains. Once a train crash occurs, a huge personal casualty and property damage will be caused. Therefore, safety and impact protection problems in train crashes have received much attention in the field of rail transit. Passive safety of trains is to dissipate and adjust crash energy through plastic deformation of an energy absorption structure of the train in the event of a crash, thereby effectively reducing impact damage to drivers and passengers. Crash energy management (CEM) is a design method that disperses the crash energy and impact to the entire train by collapsing a dedicated region of a rail vehicle. The CEM is considered an effective way to improve performance of the passive safety. Therefore, research on the CEM is of great significance in ensuring safe operation of high-speed trains.

The research shows that compared with a traditional train, a train equipped with a CEM technology achieves a higher crash safety velocity, more effectively protects living space of passengers, limits a vehicle deceleration, and reduces risks such as overriding and derailment. However, the train crash has typical material, geometric, and contact nonlinear characteristics, and there are also diverse crash scenarios and postures. Most of these complex crash problems are resolved through nonlinear finite element and multi-body dynamics simulations, but these methods have drawbacks of a large time consumption and a local optimal solution. As a prediction method in the field of artificial intelligence, machine learning can quickly and accurately extract a complex relationship between an input variable and an output target. Therefore, in recent years, the machine learning has been widely applied to resolve train crash problems due to its excellent performance, including the prediction for the dynamic response (velocity/acceleration/running attitude) during a vehicle crash.

However, existing train CEM technologies still have following problems:
1. During a train crash, an impact load is propagated from a front end of the train to a back end of the train in a form of a stress wave. As a result, too much impact energy is caused to a front impact interface, while a subsequent impact interface is almost unaffected. Moreover, different parameter settings of various crash interfaces have a significant impact on an energy absorption effect of the entire train.
2. In the prior art, research on the CEM for eight-marshalling electric multiple units (EMUs) mostly focuses on simulation research to analyze their crashworthiness and crash dynamics. Although a machine learning method has been used to improve the passive safety in a train crash, the machine learning method has not yet been used to research the CEM for high-speed trains.
3. In the prior art, the machine learning method is applied in the crash field mostly based on a simplified dynamical model or finite element simulation data of a single/three-marshalling train, which ignores a real wheel-rail rolling status and lateral and vertical effects in a crash process of an eight-marshalling train, and cannot accurately reflect a real train crash response.
4. In the prior art, research on machine learning in the crash field is mostly to construct a prediction model based on an artificial neural network with excellent prediction performance on a large dataset. However, a computational cost of a finite element simulation for a crash of an eight-marshalling train is relatively high, and only limited relevant data is accumulated. A neural network may not be suitable for fitting such a small dataset.

Based on the above shortcomings, a machine learning-based CEM optimization method for a high-speed train is proposed to further optimize and improve passive safety protection performance in the train crash, and provide theoretical support for passive safety design of the high-speed train.

### SUMMARY

In order to resolve the problems in the prior art, the present disclosure is intended to provide a train CEM optimization method based on machine learning. With the help of a machine learning method, the present disclosure can more accurately and quickly distribute crash energy of a high-speed train, thereby further improving crashworthiness and operational safety of a rail vehicle in China.

To achieve the above objective, the present disclosure adopts a following technical solution: A train CEM optimization method based on machine learning includes following steps:
step 1: establishing a finite element model that is for an eight-marshalling train crash and considers a train energy absorption subsystem and a wheel-rail rolling contact behavior;
step 2: establishing a machine learning database for train crash energy absorption;
step 3: constructing a machine learning prediction model for the train crash energy absorption; and
step 4: performing multi-objective optimization on CEM of a train based on machine learning.

As a further improvement of the present disclosure, the step 1 is specifically as follows:

establishing a finite element model of the eight-marshalling train including an energy absorption structure, a train body, a bogie, and a rail of the train, based on a characteristic of a geometric structure of the train, performing mid-plane extraction on a physical model of the train and using a four-node shell element for discretization, connecting a mid-plane model to each component of the physical model in a same manner, simulating a device on the train by using a mass element, and connecting the device on the train to the train body through a three-node beam element; based on a characteristic of a geometric structure of the bogie, discretizing a framework of the bogie, a traction device, an axle box, and a related structure by using the four-node shell element; simulating an air spring and a spring of the axle box by using a discrete beam material model, and connecting a traction base and a sleeper beam of the train body by using a rigid body and a deformable body; constructing a finite element model for wheel-rail rolling contact based on a type of a wheel tread and a rail structure, discretizing a steel rail and a wheelset by using an eight-node solid element, simulating materials of a wheel and the steel rail by using an elastic-plastic material model considering a strain rate effect, setting automatic surface-to-surface contact between wheel-rails, and locally refining a mesh of a wheel-rail contact region; based on mechanical performance of a coupler buffer device, simulating the coupler buffer device by using a discrete beam element, matching the coupler buffer device with a material model, and applying a stroke failure to the beam element, where when a stroke of the coupler buffer device exceeds a rated stroke, the beam element automatically fails; and applying a same translational velocity to both the wheelset and the train body, and applying a corresponding rotational velocity to a wheel, so as to obtain a finite element model that is for the eight-marshalling train crash and considers a crash energy absorption structure of the train body and a wheel-rail rolling contact behavior.

As a further improvement of the present disclosure, the method further includes:
establishing a dynamic constitutive relationship related to a strain rate of a material of the train body, which is specifically as follows:
using a mechanical testing & simulation (MTS) universal tester, a high-speed material tester, and a separated hopkinson bar device to study dynamic mechanical performance of a structural material of the train body within a wide strain rate range, establishing the dynamic constitutive relationship related to the strain rate of the material of the train body, and introducing the dynamic constitutive relationship into the finite element model for the train body.

As a further improvement of the present disclosure, the step 2 is specifically as follows:
based on a concept of the CEM, making energy absorption of crash interfaces of an intermediate carriage as evenly distributed as possible while ensuring that a crash interface of a train nose absorbs more energy; selecting a platform force of each energy absorption interface of a high-speed train as a characteristic parameter, selecting absorbed energy Eₐ of the crash interface of the train nose and a standard deviation σ between absorbed energy of the crash interfaces of the intermediate carriage as labels; conducting crash simulation analysis by using the finite element model for the eight-marshalling train crash, and generating a platform force sampling point for each energy absorption interface of the train by using an optimal Latin hypercube experimental design method; and performing batch calculation on train crashes of an energy absorption system under different plastic platform forces by using LS-DYNA explicit dynamics software, obtaining post-processed data based on a simulation result, performing feature extraction, and establishing a train crash energy absorption database.

As a further improvement of the present disclosure, a data size of the train crash energy absorption database is determined by drawing a learning curve.

As a further improvement of the present disclosure, the step 3 is specifically as follows:
selecting ensemble learning regression algorithms, comparing, based on a same dataset, capabilities of different algorithms in predicting the absorbed energy Eₐ and the standard deviation σ between the absorbed energy of the crash interfaces of the intermediate carriage, and selecting an appropriate model to construct a final machine learning prediction model.

As a further improvement of the present disclosure, the train crash energy absorption database is split into a training set and a test set according to a ratio of 9:1, where the training set is used to train a machine learning prediction model for crash energy absorption, in other words, is used to perform hyperparameter tuning, and the test set is retained from participating in model training and used to evaluate a finally trained machine learning prediction model.

As a further improvement of the present disclosure, a hyperparameter of the machine learning prediction model is tuned by using a 10-fold cross-validation method, which specifically includes:
in a training process, dividing the training set into ten equal subsets; selecting each subset to validate the machine learning prediction model, and using the other nine subsets to construct the model in each iteration; training a plurality of models through a plurality of repetitions, and obtaining an average score of a plurality of trained models on a corresponding validation subset; after finding a hyperparameter set with a highest score through grid search and cross-validation, performing training on the entire training set to construct a final prediction model; and finally, validating prediction performance and accuracy of a final optimal hyperparameter model by using the test set, where the prediction accuracy of the model is evaluated by using three indicators: R², mean absolute error (MAE), and root-mean-square error (RMSE).

As a further improvement of the present disclosure, the step 4 is specifically as follows:
based on the concept of the CEM, taking the coupler platform force of each energy absorption interface of the train as a design variable, and taking maximum absorbed energy of the crash interface of the train nose and a minimum standard deviation between the absorbed energy of the crash interfaces of the intermediate carriage as optimization goals, to minimize a degree of damage to the train nose and ensure even distribution of crash energy; predicting a nonlinear relationship between the design variable and the optimization goal and a constraint by using the machine learning prediction model for the train crash energy absorption, and using the nonlinear relationship obtained by the machine learning prediction model as a fitness function to establish a multi-objective optimization model for the CEM; and performing an optimization by using a non-dominated sorting genetic algorithm-II (NSGA-II) method and combining a machine learning agent model to obtain a Pareto solution set.

As a further improvement of the present disclosure, the method further includes:
based on a questionnaire survey result scored by an expert, comparing impacts of different weights of the two optimization goals on an optimization result, performing comparative analysis on the optimization result and a finite element simulation result to validate accuracy of a prediction result of the machine learning agent model, and comprehensively evaluating crashworthiness of an optimized train to validate effectiveness of an energy management method.

The present disclosure has following beneficial effects:

The present disclosure can more accurately and quickly achieve the CEM for the high-speed train, thereby further improving crashworthiness and operational safety of a rail vehicle in China. This is of great significance for sustainable and healthy development of rail transit in China.

### BRIEF DESCRIPTION OF THE DRAWINGS

FIG. 1 is a flowchart of a train CEM optimization method based on machine learning according to an embodiment of the present disclosure;

FIG. 2 shows a finite element model for an eight-marshalling standard EMU according to an embodiment of the present disclosure, where in the figure, 1 represents a coupler subsystem, 2 represents a main energy absorption structure subsystem, 3 represents a train body, 4 represents a rail, and 5 represents a bogie subsystem;

FIG. 3 is a distribution diagram of energy management and absorption interfaces of an eight-marshalling standard EMU according to an embodiment of the present disclosure;

FIGS. 4A-4B show a learning curve for determining a data volume according to an embodiment of the present disclosure;

FIGS. 5A-5D show an algorithm selection result according to an embodiment of the present disclosure;

FIGS. 6A-6B analyze a machine learning-based energy absorption prediction result and error according to an embodiment of the present disclosure; and

FIG. 7 shows a Pareto solution set according to an embodiment of the present disclosure.

### DETAILED DESCRIPTION OF THE EMBODIMENTS

The embodiments of the present disclosure are described in detail below with reference to the accompanying drawings.

### Embodiment 1

A train CEM optimization method based on machine learning includes following steps:
S1: A finite element model that is for an eight-marshalling train crash and considers a train energy absorption subsystem and a wheel-rail rolling contact behavior is established.
S2: A machine learning database for train crash energy absorption is established.
S3: A machine learning prediction model for the train crash energy absorption is constructed.
S4: Multi-objective optimization is performed on CEM of a train based on machine learning.

In the S1, a process of establishing the finite element model that is for the eight- marshalling train crash and considers the train energy absorption subsystem and the wheel-rail rolling contact behavior is as follows:

A finite element model of the eight-marshalling train is established, including an energy absorption structure, a train body, a bogie, and a rail of the train. Based on a characteristic of a geometric structure of the train, mid-plane extraction is performed on a physical model of the train, and a four-node shell element is used for discretization. A mid-plane model is connected to each component of the physical model in a same manner, and a device on the train is simulated by using a mass element and connected to the train body through a three-node beam element. Based on a characteristic of a geometric structure of the bogie, a framework of the bogie, a traction device, an axle box, and a related structure are discretized by using the four-node shell element. An air spring and a spring of the axle box are simulated by using a discrete beam material model, and a traction base and a sleeper beam of the train body are connected by using a rigid body and a deformable body. A finite element model for wheel-rail rolling contact is constructed based on a type of a wheel tread and a rail structure, a steel rail and a wheelset are discretized by using an eight-node solid element, materials of a wheel and the steel rail are simulated by using an elastic-plastic material model considering a strain rate effect, automatic surface-to-surface contact is set between wheel-rails, and a mesh of a wheel-rail contact region is locally refined.

A same translational velocity is applied to both the wheelset and the train body, and a corresponding rotational velocity is applied to a wheel, so as to obtain a finite element model that is for the eight-marshalling train crash and considers a crash energy absorption structure of the train body and a wheel-rail rolling contact behavior.

Based on mechanical performance of a coupler buffer device, the coupler buffer device is simulated by using a discrete beam element and matched with a material model, and a stroke failure is applied to the beam element. When a stroke of the coupler buffer device exceeds a rated stroke, the beam element automatically fails.

A processing of establishing a dynamic constitutive relationship related to a strain rate of a material of the train body is as follows: An MTS universal tester, a high-speed material tester, and a separated hopkinson bar device are used to study dynamic mechanical performance of a structural material of the train body within a wide strain rate range. The dynamic constitutive relationship related to the strain rate of the material of the train body is established and introduced into the finite element model for the train body.

In the S2, a processing of establishing the machine learning database for the train crash energy absorption is as follows:

During a train crash, an impact load is propagated from a front end of the train to a back end of the train in a form of a stress wave. As a result, an impact point absorbs more energy than a subsequent crash interface, and absorbed energy of each crash interface varies greatly. For a crash interface of a first carriage, a coupler and a main energy absorption structure absorb insufficient energy, resulting in plastic deformation of the first carriage. A crash interface of an intermediate carriage close to a crash end of the first carriage absorbs much energy, causing a coupler failure, but a subsequent crash interface far from the crash end of the first carriage hardly participates in energy absorption. Based on a concept of the CEM, energy absorption of crash interfaces of the intermediate carriage should be as evenly distributed as possible, while it is ensured that a crash interface of a train nose absorbs more energy. Therefore, a platform force of each energy absorption interface of a high-speed train is selected as a characteristic parameter, and absorbed energy (Ea) of the crash interface of the train nose and a standard deviation (o) between absorbed energy of the crash interfaces of the intermediate carriage are selected as labels.

Crash simulation analysis is conducted by using the established finite element model for the eight-marshalling train crash in the S1. A train crash scenario is set according to EN15227, where a moving eight-marshalling train collides head-on with another stationary eight-marshalling train under a velocity of 36 km/h. A platform force sampling point is generated for each energy absorption interface of the train by using an optimal Latin hypercube experimental design method. As a multi-dimensional stratified sampling method, optimal Latin hypercube design can generate any quantity of sample points, such that all sample points are evenly distributed in design space. Parameter research requires a plurality of iterations of the finite element model. Therefore, batch calculation is performed on train crashes of an energy absorption system under different plastic platform forces by using LS-DYNA explicit dynamics software. Post-processed data is obtained based on a simulation result, feature extraction is performed, and a train crash energy absorption database is established. The database is split into a training set and a test set according to a ratio of 9:1. The training set is used to train a machine learning prediction model for crash energy absorption, and the test set is used to evaluate a trained final model.

A data size of the machine learning database for the train crash energy absorption is determined by drawing a learning curve. As a sample data size increases, prediction accuracy of the model gradually increases and eventually tends to be stable. When a further increase in the sample data size has a little impact on the accuracy of the model, a size of data used to construct an energy absorption prediction model is determined.

In the S3, a processing of constructing the machine learning prediction model for the train crash energy absorption is as follows:

Four common ensemble learning regression algorithms (XGBoost algorithm, GBDT algorithm, ExtraTrees algorithm, and Random Forest algorithm) are selected. Capabilities of the different algorithms in predicting the Eₐ and the σ are compared based on a same dataset, and an appropriate prediction model is selected to construct a final energy absorption prediction model.

The established machine learning database for the train crash energy absorption in the S2 is randomly divided into two sets according to a ratio of 9:1, namely, a training set and a test set. The test set is retained from participating in model training to avoid information leakage, while the training set is used solely for hyperparameter tuning. In order to minimize a potential error caused by random sampling of the training set and prevent overfitting of the model, a 10-fold cross-validation method is used to tune a hyperparameter of the model. In a training process, the training set is divided into ten equal subsets. Each subset is selected to validate the model, and the other nine subsets are used to construct the model in each iteration. This operation is repeated ten times to train ten models, and an average score of ten trained models on a corresponding validation subset is obtained.

A most commonly used method for exploring hyperparameter configuration space is a grid search strategy, which is also used to find an optimal hyperparameter combination. After a hyperparameter set with a highest score is found through grid search and cross-validation, training is performed on the entire training set to construct a final prediction model. Finally, prediction performance and accuracy of a final optimal hyperparameter model are validated by using the test set. The prediction accuracy of the model is evaluated by using three indicators: R², MAE, and RMSE.

In the S4, a process of performing the multi-objective optimization on the CEM of the train based on the machine learning is as follows:

Based on the concept of the CEM, the coupler platform force of each energy absorption interface of the train is taken as a design variable, and maximum absorbed energy of the crash interface of the first carriage and a minimum standard deviation between the absorbed energy of the crash interfaces of the intermediate carriage are taken as optimization goals, to minimize a degree of damage to the train nose and ensure even distribution of crash energy. Due to a plurality of variables, nonlinearity, and strong coupling in a train crash process, a traditional response surface model cannot achieve an effective fitting effect. A hybrid framework based on a combination of the machine learning and a multi-objective optimization method is proposed. A nonlinear relationship between the design variable and the optimization goal and a constraint is predicted by using the established machine learning prediction model for the train crash energy absorption in the S3, and the nonlinear relationship obtained by the machine learning prediction model is used as a fitness function to establish a multi-objective optimization model for the CEM. An optimization is performed by using an NSGA-II method and combining a machine learning agent model to obtain a Pareto solution set.

Based on a questionnaire survey result scored by an expert, impacts of different weights of the two optimization goals on an optimization result are discussed, comparative analysis is performed on the optimization result and a finite element simulation result to validate accuracy of a prediction result of the machine learning agent model, and crashworthiness of an optimized train is comprehensively evaluated to validate effectiveness of an energy management method.

### Embodiment 2

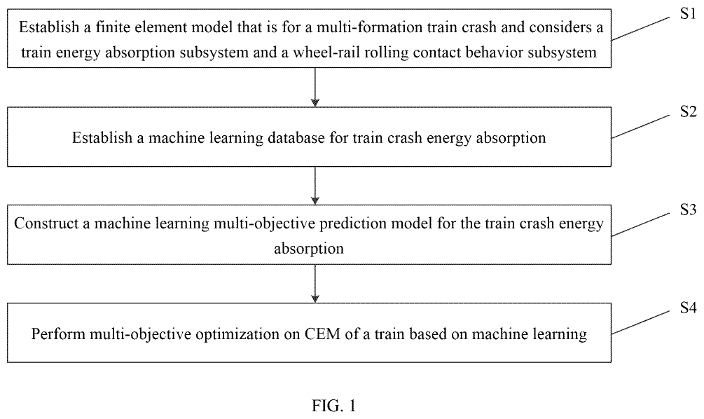

As shown in FIG. 1, a train CEM optimization method based on machine learning according to an embodiment of the present disclosure includes following steps:
S1: A finite element model that is for an eight-marshalling train crash and considers a train energy absorption subsystem and a wheel-rail rolling contact behavior is established.
S2: A machine learning database for train crash energy absorption is established.
S3: A machine learning prediction model for the train crash energy absorption is constructed.
S4: Multi-objective optimization is performed on CEM of a train based on machine learning.

In the S1, a process of establishing the finite element model that is for the eight-marshalling train crash and considers the train energy absorption subsystem and the wheel-rail rolling contact behavior is as follows:

A finite element model of the eight-marshalling train is established, including an energy absorption structure, a train body, a bogie, and a rail of the train. Based on a characteristic of a geometric structure of the train, mid-plane extraction is performed on a physical model of the train, and a four-node shell element is used for discretization. A mid-plane model is connected to each component of the physical model in a same manner, and a device on the train is simulated by using a mass element and connected to the train body through a three-node beam element.

A finite element model for wheel-rail rolling contact is constructed based on a type of a wheel tread and a rail structure. A steel rail and a wheelset are discretized by using an eight- node solid element. Materials of a wheel and the steel rail are simulated by using an elastic-plastic material model *MAT PIECEWISE LINEAR PLASTICITY considering a strain rate effect. Automatic surface-to-surface contact is set between wheel-rails, and a mesh of a wheel-rail contact region is locally refined. If deformation of the wheel-rail in a crash process is not considered, in order to save a computational cost, a material of the wheel-rail can also be simulated by using a rigid material *MAT-RIGID rigid material.

For a ballastless rail structure, a rail slab and a mortar layer can be simulated by using a *MAT-ELASTIC material model, a fastening system is simplified by using a spring-damping element, and *MAT-SPRING-ELASTIC and *MAT-DAMPER-VISCOUS material models can be used for simulation.

A same translational velocity is applied to both the wheelset and the train body, and a corresponding rotational velocity is applied to a wheel, to simulate a wheel-rail rolling contact behavior. In this way, a finite element model that is for the eight-marshalling train crash and considers a crash energy absorption structure of the train body and the wheel-rail rolling contact behavior is obtained.

In a processing of establishing the finite element model that is for the eight-marshalling train crash and considers the train energy absorption subsystem and the wheel-rail rolling contact behavior in the S1, based on mechanical performance of a coupler buffer device, the coupler buffer device is simulated by using a discrete beam element and matched with a *MAT GENERAL NONLINEAR 6DOF_DISCRETE BEAM material model, and a stroke failure is applied to the beam element. When a stroke of the coupler buffer device exceeds a rated stroke, the beam element automatically fails. Basic parameters of the train energy absorption subsystem are shown in Table 1.

TABLE 1
Basic parameters of the train energy absorption subsystem

| | Fully | Main energy | Semi- |
|---|---|---|---|
| | automatic | absorption | permanent |
| Parameter | coupler | device | coupler |
| Buffer stroke (m) | 0.1 | — | 0.062 |
| Energy absorbed by a | 65 | — | 32 |
| buffer (kJ) | | | |
| Stroke of a crushed | 0.6 | 0.65 | 0.38 |
| pipe (m) | | | |
| Plastic platform force | 1500 | 2800 | 1500 |
| (kN) | | | |

Based on a characteristic of a geometric structure of the bogie, a framework of the bogie, a traction device, an axle box, and a related structure are discretized by using the four-node shell element. A material of a main structure of the bogie is Q345. In order to reduce a computational load and shorten computation time, deformation of the bogie is not considered in the crash process. Therefore, the bogie is set as a rigid body. An air spring and a spring of the axle box are simulated by using a discrete beam material model *MAT LINEAR ELASTIC DISCRETE_BEAM, and a traction base and a sleeper beam of the train body are connected by using *MAT_LINEAR_ELASTIC DISCRETE BEAM.

A process of establishing a dynamic constitutive relationship related to a strain rate of a material of the train body is as follows:

An MTS universal tester, a high-speed material tester, and a separated hopkinson bar device are used to study dynamic mechanical performance of a structural material of the train body within a wide strain rate range. The dynamic constitutive relationship related to the strain rate of the material of the train body is established and introduced into the finite element model for the train body.

In the S2, a processing of establishing the machine learning database for the train crash energy absorption is as follows:

During a train crash, an impact load is propagated from a front end of the train to a back end of the train in a form of a stress wave. As a result, an impact point absorbs more energy than a subsequent crash interface, and absorbed energy of each crash interface varies greatly. Based on a concept of the CEM, energy absorption of crash interfaces of an intermediate carriage should be as evenly distributed as possible, while it is ensured that a crash interface of a train nose absorbs more energy. Therefore, a platform force of each energy absorption interface of a high-speed train is selected as a characteristic parameter, and absorbed energy (Eₐ) of the crash interface of the train nose and a standard deviation (σ) between absorbed energy of the crash interfaces of the intermediate carriage are selected as labels. A calculation formula of the σ is as follows:

$$σ = \sqrt{\frac{1}{14} {\sum }_{i = 1}^{14} ( {E}_{mi} - {E}_{ma} )}$$

In the above formula, Eₘᵢ represents absorbed energy of crash interface i of the intermediate carriage, and Eₘₐ represents an average value of the absorbed energy of the crash interfaces of the intermediate carriage.

Crash simulation analysis is conducted by using the established finite element model for the eight-marshalling train crash in the S1. A train crash scenario is set according to EN15227, where a moving eight-marshalling train collides head-on with another stationary eight-marshalling train under a velocity of 36 km/h. A platform force sampling point is generated for each energy absorption interface of the train by using an optimal Latin hypercube experimental design method. As a multi-dimensional stratified sampling method, optimal Latin hypercube design can generate any quantity of sample points, such that all sample points are evenly distributed in design space. Value ranges of characteristic parameters are shown in Table 2.

TABLE 2
Value ranges of the characteristic parameters

| | Fully | Main energy | | | | |
|---|---|---|---|---|---|---|
| | automatic | absorption | Semi-permanent | | | |
| Characteristic | coupler | structure | coupler | | | |
| parameter | F₁ | F₂ | F₃ | F₄ | F₅ | F₆ |

| | | | |
|---|---|---|---|
| Initial value (kN) | 1500 | 2800 | 1500 |
| Value range (kN) | [1200, 1800] | [2300, 3300] | [1200, 1800] |

Parameter research requires a plurality of iterations of the finite element model. Therefore, batch calculation is performed on train crashes of an energy absorption system under different plastic platform forces by using LS-DYNA explicit dynamics software. Post-processed data is obtained based on a simulation result, feature extraction is performed, and a train crash energy absorption database is established. The database is split into a training set and a test set according to a ratio of 9:1. The training set is used to train a machine learning prediction model for crash energy absorption, and the test set is used to evaluate a trained final model.

A data size of the machine learning database for the train crash energy absorption is determined by drawing a learning curve. As a sample data size increases, prediction accuracy of the model gradually increases and eventually tends to be stable. When a further increase in the sample data size has a little impact on the accuracy of the model, a size of data used to construct an energy absorption prediction model is determined.

In the S3, a processing of constructing the machine learning prediction model for the train crash energy absorption is as follows:

Four common ensemble learning regression algorithms (XGBoost algorithm, GBDT algorithm, Random Forest algorithm, and ExtraTrees algorithm) are selected. Capabilities of the different algorithms in predicting the Eₐ and the σ are compared based on a same dataset, and an appropriate prediction model is selected to construct a final energy absorption prediction model.

The XGBoost algorithm can integrate a plurality of weak learning machines into a strong learning machine by iterating and generating a plurality of trees. The XGBoost algorithm has characteristics of automatically using multithreading of a central processing unit (CPU) for parallelism, improving the algorithm to improve accuracy, automatically processing sparse data, and processing a large amount of data at a high velocity based on a block technology. In an XGBoost model, a tree model adopts an additive model.

$$y = {\sum }_{k = 1}^{K} {f}_{k} ( {x}_{i} ) , {f}_{k} ∈ F$$

An objective function is as follows:

$$L ( φ ) = {\sum }_{i} l ( y , {y}_{i} ) + {\sum }_{k} Ω ( {f}_{k} )$$

In the above objective function, Ω(f)=γT+0.5λw², w=(w₁, w₂, . . . , Wₖ). The XGBoost algorithm uses a stepwise forward additive model as a gradient boosting algorithm. Different from the gradient boosting algorithm that is a negative gradient, the XGBoost algorithm learns a weak learner to approximate a loss function. The XGBoost algorithm first finds a second-order Taylor approximation of the loss function at that point, and then minimizes an approximate loss function to train the weak learner. Therefore, the objective function can be expressed as follows:

$${L}^{( t )} = {\sum }_{i = 1}^{n} [ {g}_{i} {f}_{i} ( {x}_{i} ) + 0.5 {h}_{i} {f}_{t}^{2} ( {x}_{i} ) ] + Ω ( {f}_{t} )$$

The GBDT algorithm is an ensemble learning algorithm based on a gradient enhancement framework, and its basic model is a classification and regression tree (CART). For the GBDT algorithm, in each step, a CART model is trained to fit a negative gradient of a loss function of an intermediate GBDT model. Next, after a new trained CART is introduced, the loss function of the GBDT model is minimized in a negative gradient direction, effectively improving performance of the GBDT model. For a regression problem with an input vector of x and a target output of y, a total quantity of training samples is n. In step t of a training iteration of the GBDT algorithm, composite model Fₜ(x) can be represented as follows:

$${F}_{t} ( x ) = {\sum }_{i = 1}^{t - 1} {T}_{i} ( x , {θ}_{i} )$$

In the above model, Fₜ(x) is a composite GBDT model in a t^{th} step, which is constituted by t-1 CART models Tᵢ(x,θᵢ), and θ represents a hyperparameter vector of the CART model. Then, in a (t+1)^{th} step, new CART model Tₜ(x;θₜ) trains loss function rₜ(x) of the Fₜ(x) based on a negative gradient:

$${T}_{i} ( x , {θ}_{t} ) \to {r}_{t} = - \frac{\partial L [ {F}_{t - 1} ( {x}_{i} ) , {y}_{i} ]}{\partial {F}_{t - 1} ( {x}_{i} )}$$

L[f(x),y] is a loss function of model f(x). Training process Tₜ(x;θₜ) is equal to a process of minimizing a residual error of the GBDT model. Through M iteration steps, M CART models are sequentially combined to obtain a GBDT model with a strong generalization intensity:

$$F ( x ) = {F}_{M} ( x ) = {\sum }_{i = 1}^{M} {T}_{i} ( x ; {θ}_{i} )$$

Like the GBDT algorithm, the Random Forest algorithm also uses the CART as a basic model. However, basic models in the Random Forest algorithm are trained in parallel and completely independent of each other. For a regression problem, a final prediction result is obtained by averaging all CARTs.

$$F ( x ) = \frac{1}{M} {\sum }_{i = 1}^{M} {F}_{i} ( x ) = \frac{1}{M} {\sum }_{i = 1}^{M} {T}_{i} ( x ; θ )$$

In a training process of the CART model Tₜ(x;θₜ), the Random Forest algorithm randomly selects m samples from training database {x₁, x₂, . . . , xₘ}, and replaces the m samples to first generate new database {x}^{t}. In addition, the CART model in the Random Forest algorithm not only is trained by using the sampling database {x}^{t}, but also randomly selects a subset of input feature [x₁^{t}, . . . , xₖ^{t}]_{1×k}. Then, when each node splitting of the CART is trained, split feature xᵢⱼ is searched for from selected k features instead of original n features of x. On the database {x}^{t} sampled by using bootstrap, fitted value θⱼ of each leaf node is optimized by using a same process in the GBDT algorithm:

$${min}_{{x}_{tj} , S} [ {min}_{{θ}_{1}} {\sum }_{{x}_{i} ∈ Nodes ( {xt}_{j} , S )} ( {y}_{i} - {θ}_{j 1} ) + {min}_{{θ}_{2}} {\sum }_{{x}_{i} ∈ Nodes ( {xt}_{j} , S )} ( {y}_{i} - {θ}_{j 2} ) ] , {x}_{i} ∈ {\{ x \}}^{t}$$

These two random processes in the Random Forest algorithm effectively reduce a correlation between CARTs, thereby increasing stability of the Random Forest algorithm.

The Extra Trees algorithm develops as an extension of the Random Forest algorithm. The ExtraTrees algorithm uses a classic top-down process to construct a set of untrimmed regression trees. The ExtraTrees algorithm uses a random subset of a feature to train each base estimator, which is the same as a principle adopted by the Random Forest algorithm. However, the ExtraTrees algorithm does not select a most discriminative segmentation in each node, but randomly selects an optimal feature and a corresponding value to segment the node. In addition, the Random Forest algorithm trains a prediction model through bootstrap replication, while the ExtraTrees algorithm uses the entire training set to train each regression tree in a forest.

The established machine learning database for the train crash energy absorption in the S2 is randomly divided into two sets according to a ratio of 9:1, namely, a training set and a test set. The test dataset is retained from participating in model training to avoid information leakage, while the training set is used solely for hyperparameter tuning. In order to minimize a potential error caused by random sampling of the training set and prevent overfitting of the model, a 10-fold cross-validation method is used to tune a hyperparameter of the model. In a training process, the training set is divided into ten equal subsets. Each subset is selected to validate the model, and the other nine subsets are used to construct the model in each iteration. This operation is repeated ten times to train ten models, and an average score of ten trained models on a corresponding validation subset is obtained.

A most commonly used method for exploring hyperparameter configuration space is a grid search strategy, which is also used to find an optimal hyperparameter combination. A model with two hyperparameters is used as an example. The parameters α and β have four possibilities. All the possibilities are listed to obtain a 4×4 table, and a cyclic process is to perform traversal and search in each grid. After a hyperparameter set with a highest score is found through grid search and cross-validation, training is performed on the entire training set to construct a final prediction model. Finally, prediction performance and accuracy of a final optimal hyperparameter model are validated by using the test set. The prediction accuracy of the model is evaluated by using three indicators: R², MAE, and RMSE. The three indicators are expressed as follows:

$${R}^{2} = 1 - \frac{{\sum }_{i = 1}^{n} {( {y}_{i} - {y}_{i} )}^{2}}{{\sum }_{i = 1}^{n} {( {y}_{i} - \overline{{y}_{i}} )}^{2}}$$

$$MAE = \frac{1}{n} {\sum }_{i = 1}^{n} \vert {y}_{i} - {y}_{i} \vert$$

$$RMSE = \sqrt{\frac{1}{n} {\sum }_{i = 1}^{n} {( {y}_{i} - {y}_{i} )}^{2}}$$

10-fold cross-validation results of the four models on the training set are compared to evaluate model accuracy. Model robustness is evaluated based on an R² distribution in the 10-fold cross-validation results, and a machine learning prediction model suitable for different energy absorption targets is comprehensively selected.

In the S4, a process of performing the multi-objective optimization on the CEM of the train based on the machine learning is as follows:

Based on the concept of the CEM, the coupler platform force of each energy absorption interface of the train is taken as a design variable, and maximum absorbed energy of the crash interface of the first carriage and a minimum standard deviation between the absorbed energy of the crash interfaces of the intermediate carriage are taken as optimization goals, to minimize a degree of damage to the train nose and ensure even distribution of crash energy. Due to a plurality of variables, nonlinearity, and strong coupling in a train crash process, a traditional response surface model cannot achieve an effective fitting effect. A hybrid framework based on a combination of the machine learning and a multi-objective optimization method is proposed. A nonlinear relationship between the design variable and the optimization goal and a constraint is predicted by using the established machine learning prediction model for the train crash energy absorption in the S3, and the nonlinear relationship obtained by the machine learning prediction model is used as a fitness function to establish a multi-objective optimization model for the CEM. An optimization is performed by using an NSGA-II method and combining a machine learning agent model to obtain a Pareto solution set.

Based on a questionnaire survey result scored by an expert, impacts of different weights of the two optimization goals on an optimization result are discussed to determine an optimal weight. Comparative analysis is performed on the optimization result and a finite element simulation result to validate accuracy of a prediction result of the machine learning agent model, and crashworthiness of an optimized train is comprehensively evaluated to validate effectiveness of an energy management method.

The present disclosure is further described below by using an eight-marshalling standard EMU of a model as an example.

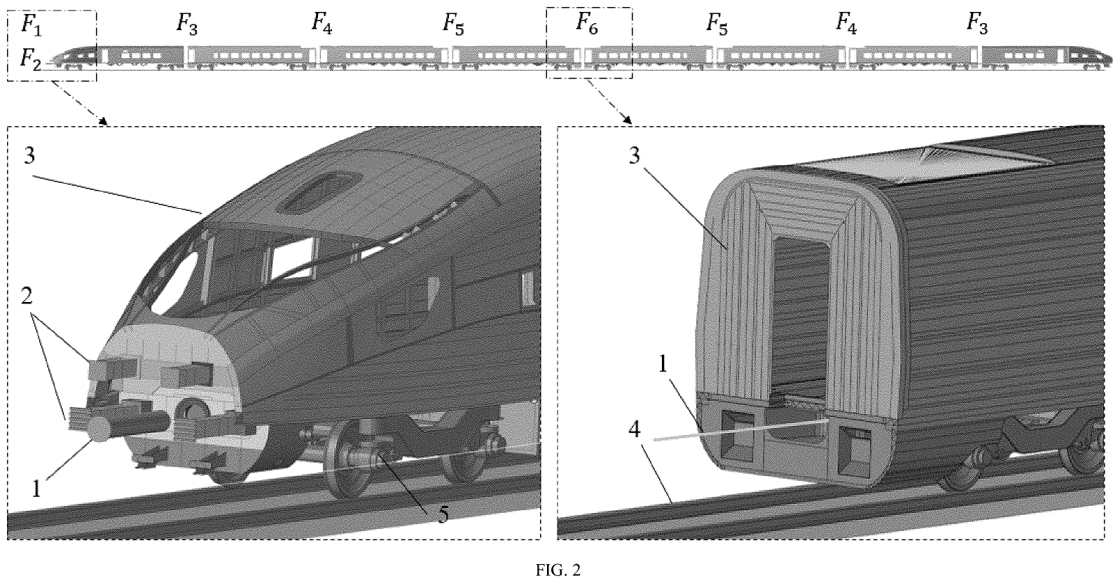

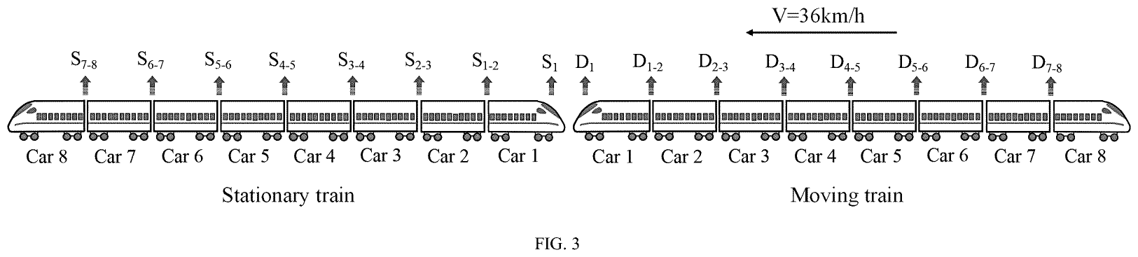

As shown in FIG. 2, a multi-body finite element model for the eight-marshalling standard EMU is constructed. A platform force of each energy absorption interface of the EMU is taken as a characteristic parameter, and absorbed energy (Eₐ) of a crash interface of a train nose and a standard deviation (θ) between absorbed energy of various crash interfaces of an intermediate carriage are selected as labels. The characteristic parameter is sampled by using the optimal Latin hypercube experimental design method, and finite element simulation is conducted under a crash condition shown in FIG. 3.

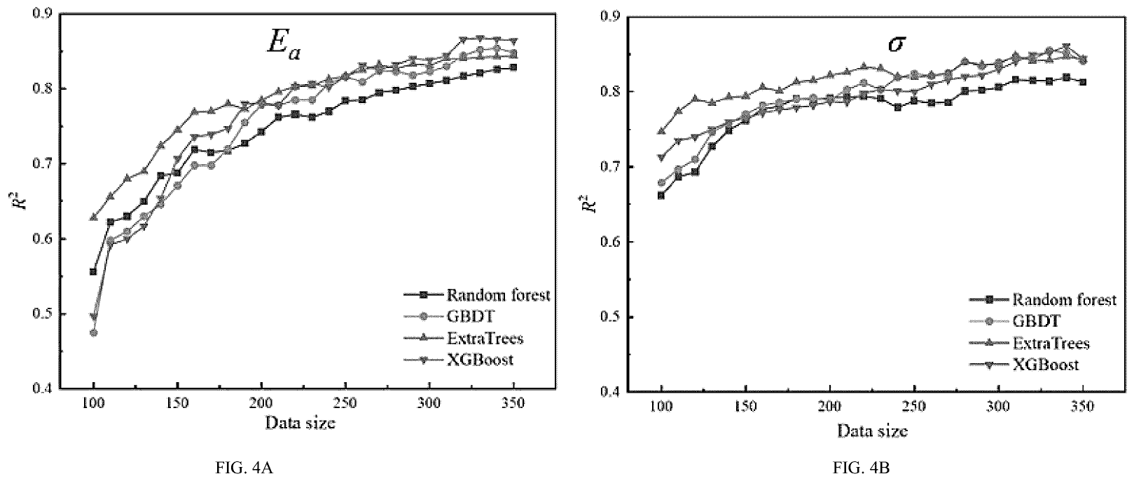

A crash energy absorption database of the machine learning is constructed based on a simulation result, and a data size is determined by drawing a learning curve. Results are shown in FIGS. 4A-4B.

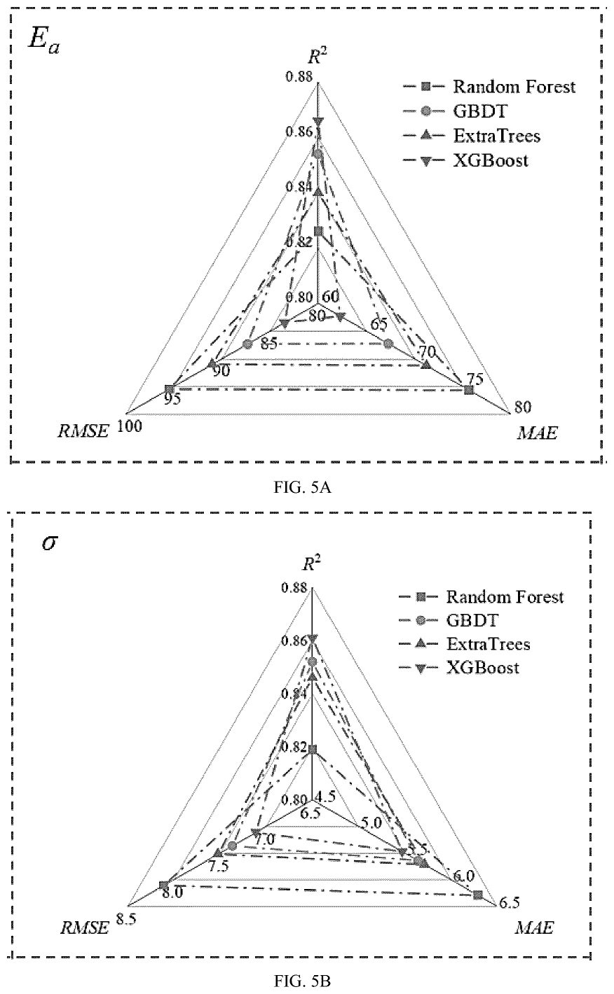

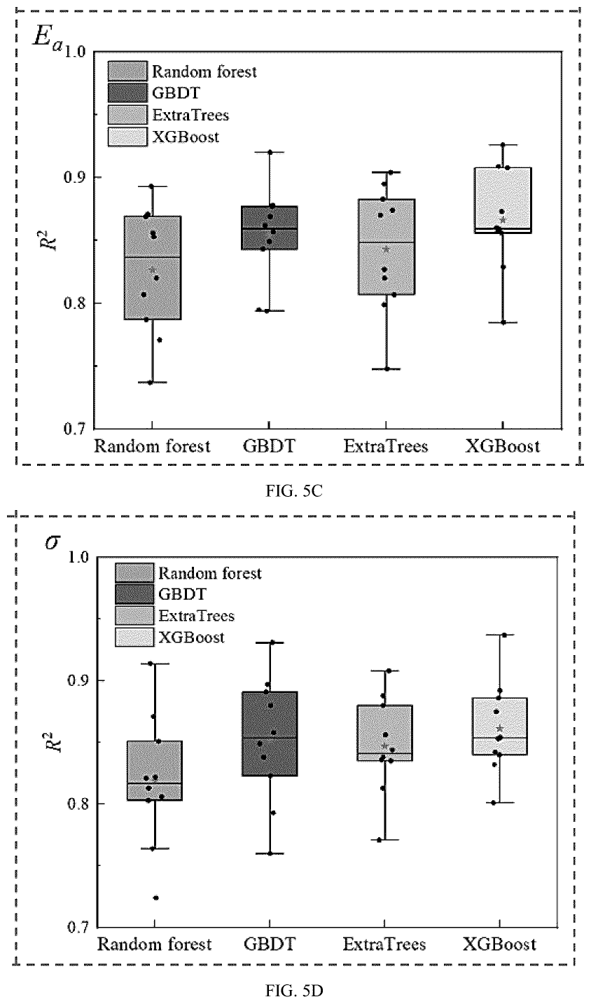

Based on the established machine learning database, four ensemble learning methods are used to predict the Eₐ and the θ, and accuracy and R² distributions in 10-fold cross-validation results of different models are compared. Results are shown in FIGS. 5A-5D. Finally, the XGBoost algorithm is selected to predict the Eₐ and the θ.

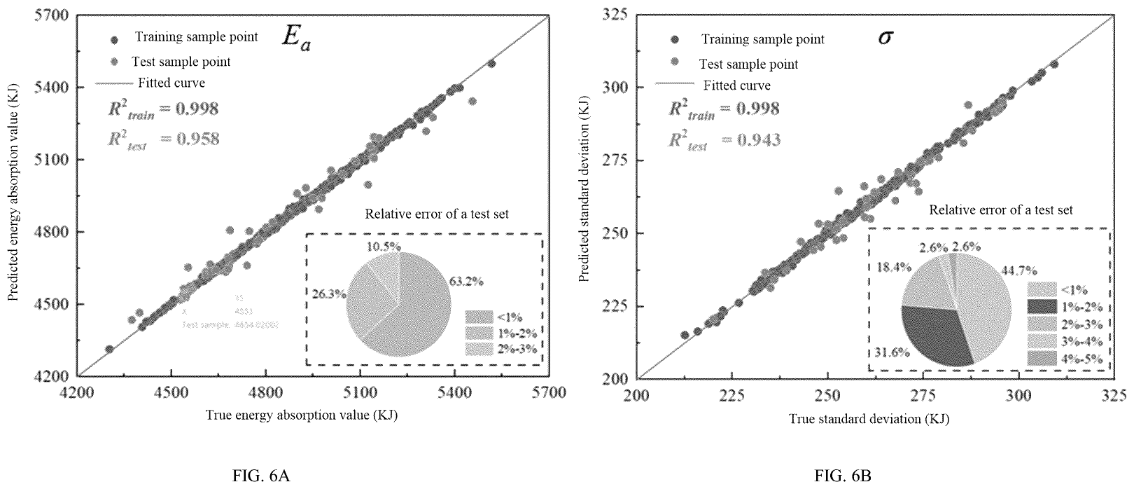

A final prediction result of the XGBoost algorithm on the test set is shown in FIGS. 6A-6B. Prediction accuracy of the Eₐ and prediction accuracy of the θ respectively reach 0.958 and 0.943, and a maximum error on the test set does not exceed 5%. This indicates that the constructed energy absorption prediction model has sufficient accuracy.

The established energy absorption prediction model of the machine learning is used as a fitness function of a multi-objective optimization algorithm to represent a complex nonlinear relationship between an input variable and an output target. By taking the platform force of each energy absorption interface of the EMU as an independent variable, and setting optimization goals of maximizing the E^{a} and minimizing the θ, an optimal theory model is established as follows:

$$\{ \begin{matrix}Max [ {E}_{a} ( {F}_{i} ) , i = 1 , 2 , 3 , 4 , 5 , 6 ] \\ Min [ σ ( {F}_{i} ) , i = 1 , 2 , 3 , 4 , 5 , 6 ] \\ s . t . \\ 1200 kN \leq {F}_{1} \leq 1800 kN \\ 2800 kN \leq {F}_{2} \leq 3300 kN \\ 1200 kN \leq {F}_{3} , {F}_{4} , {F}_{5} , {F}_{6} \leq 1800 kN\end{matrix}$$

As described above, Fᵢ(i=1,2, . . . ,6) represents a platform force of an ith energy absorption interface, and a distribution of F1 to F6 is shown in FIG. 2.

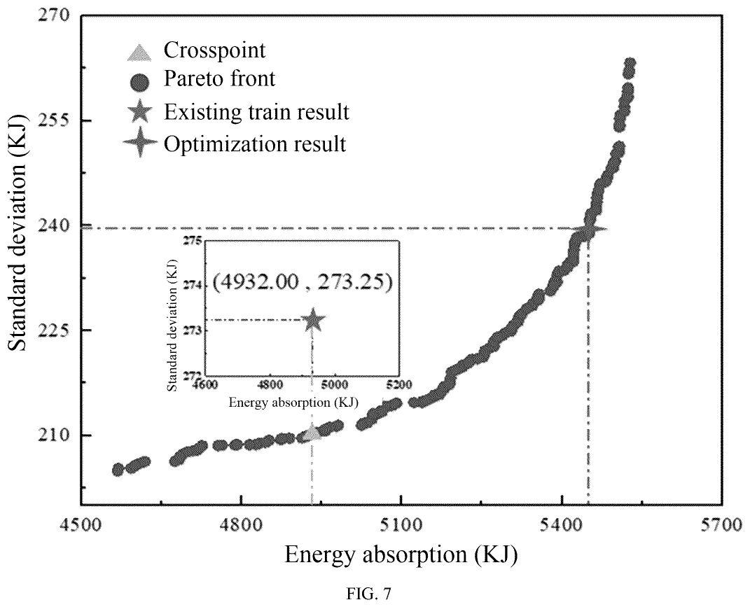

An optimization is performed by using the NSGA-II method and combining a machine learning agent model to obtain a Pareto solution set. By comparing an optimization result with a result achieved by an existing solution, it can be concluded that an optimized solution has better CEM performance, as shown in FIG. 7.

Based on the questionnaire survey result scored by the expert, five groups of different weights are assigned to the two optimization goals. Optimization results under the different weights are shown in Table 3. When weights of the Eₐ and the θ are 0.7 and 0.3 respectively, a best optimization result is achieved.

TABLE 3
Optimization results under the different target weights

| | 1 | | 2 | | 3 | | 4 | | 5 | |
|---|---|---|---|---|---|---|---|---|---|---|
| Group | ω₁ | ω₂ | ω₁ | ω₂ | ω₁ | ω₂ | ω₁ | ω₂ | ω₁ | ω₂ |
| Target weight | 0.4 | 0.6 | 0.5 | 0.5 | 0.6 | 0.4 | 0.7 | 0.3 | 0.8 | 0.2 |

| | | | | | |
|---|---|---|---|---|---|
| Eₐ (kJ) | 5169.87 | 5169.87 | 5378.46 | 5450.54 | 5506.44 |
| σ (kJ) | 215.87 | 215.87 | 230.67 | 238.85 | 250.46 |

The optimization result and the simulation result are validated, as shown in Table 4, with errors of 3.81% and 3.01% respectively, which are within allowable ranges. Compared with the existing solution, the optimized solution increases the Eₐ by 10.51% and reduces the θ by 12.59% after a crash. This indicates that the present disclosure is reliable in research on the CEM.

TABLE 4
Validation of the optimization result and the simulation result

| | F₁ (kN) | F₂ (kN) | F₃ (kN) | F₄ (kN) | F₅ (kN) | F₆ (kN) | Eₐ (kJ) | σ (kJ) |
|---|---|---|---|---|---|---|---|---|
| Existing | 1500.00 | 2800.00 | 1500.00 | 1500.00 | 1500.00 | 1500.00 | 4932.00 | 273.25 |
| solution | | | | | | | | |
| Optimized | 1784.69 | 2881.38 | 1596.43 | 1353.44 | 1765.68 | 1200.64 | 5450.54 | 238.85 |
| result | | | | | | | | |
| Simulation | 1784.69 | 2881.38 | 1596.43 | 1353.44 | 1765.68 | 1200.64 | 5243.00 | 246.06 |
| result | | | | | | | | |

The above embodiments are merely illustrative of specific implementations of the present disclosure, and the description thereof is specific and detailed, but should not be construed as limiting the patent scope of the present disclosure. It should be noted that those of ordinary skill in the art can further make several variations and improvements without departing from the concept of the present disclosure, and all of these fall within the protection scope of the present disclosure.

What is claimed is:

1. A train crash energy management (CEM) optimization method based on machine learning, comprising following steps:
step 1: establishing a finite element model, wherein the finite element model is for an eight-marshalling train crash and considers a train energy absorption subsystem and a wheel-rail rolling contact behavior;
step 2: establishing a machine learning database for train crash energy absorption;
step 3: constructing a machine learning prediction model for the train crash energy absorption; and
step 4: performing multi-objective optimization on CEM of a train based on the machine learning.

2. The train CEM optimization method based on the machine learning according to claim 1, wherein the step 1 is as follows:
establishing a finite element model of the eight-marshalling train including an energy absorption structure, a train body, a bogie, and a rail of the train, based on a characteristic of a geometric structure of the train, performing mid-plane extraction on a physical model of the train and using a four-node shell element for discretization, connecting a mid-plane model to each component of the physical model in a same manner, simulating a device on the train by using a mass element, and connecting the device on the train to the train body through a three-node beam element;
based on a characteristic of a geometric structure of the bogie, discretizing a framework of the bogie, a traction device, an axle box, and a related structure by using the four-node shell element;
simulating an air spring and a spring of the axle box by using a discrete beam material model, and connecting a traction base and a sleeper beam of the train body by using a rigid body and a deformable body;
constructing a finite element model for wheel-rail rolling contact based on a type of a wheel tread and a rail structure, discretizing a steel rail and a wheelset by using an eight-node solid element, simulating materials of a wheel and the steel rail by using an elastic-plastic material model considering a strain rate effect, setting automatic surface-to-surface contact between wheel-rails, and locally refining a mesh of a wheel-rail contact region;
based on mechanical performance of a coupler buffer device, simulating the coupler buffer device by using a discrete beam element, matching the coupler buffer device with a material model, and applying a stroke failure to the discrete beam element, wherein when a stroke of the coupler buffer device exceeds a rated stroke, the discrete beam element automatically fails; and
applying a same translational velocity to both the wheelset and the train body, and applying a corresponding rotational velocity to the wheel, to obtain the finite element model, wherein the finite element model is for the eight-marshalling train crash and considers a crash energy absorption structure of the train body and a wheel-rail rolling contact behavior.

3. The train CEM optimization method based on the machine learning according to claim 2, further comprising: establishing a dynamic constitutive relationship related to a strain rate of a material of the train body, comprising:
using a mechanical testing & simulation (MTS) universal tester, a high-speed material tester, and a separated hopkinson bar device to study dynamic mechanical performance of a structural material of the train body within a wide strain rate range, establishing the dynamic constitutive relationship related to the strain rate of the material of the train body, and introducing the dynamic constitutive relationship into the finite element model for the train body.

4. The train CEM optimization method based on the machine learning according to claim 2, wherein the step 2 is as follows:
based on a concept of the CEM, making energy absorption of crash interfaces of an intermediate carriage as evenly distributed as possible while ensuring that a crash interface of a train nose absorbs more energy;
selecting a platform force of each energy absorption interface of a high-speed train as a characteristic parameter, selecting absorbed energy Ea of the crash interface of the train nose and a standard deviation o between absorbed energy of the crash interfaces of the intermediate carriage as labels;
conducting crash simulation analysis by using the finite element model for the eight-marshalling train crash, and generating a platform force sampling point for each energy absorption interface of the train by using an optimal Latin hypercube experimental design method; and
performing batch calculation on train crashes of an energy absorption system under different plastic platform forces by using LS-DYNA explicit dynamics software, obtaining post-processed data based on a simulation result, performing feature extraction, and establishing a train crash energy absorption database.

5. The train CEM optimization method based on the machine learning according to claim 4, wherein a data size of the train crash energy absorption database is determined by drawing a learning curve.

6. The train CEM optimization method based on the machine learning according to claim 4, wherein the step 3 is as follows:
selecting ensemble learning regression algorithms, comparing, based on a same dataset, capabilities of different algorithms in predicting the absorbed energy Eₐ and the standard deviation θ between the absorbed energy of the crash interfaces of the intermediate carriage, and selecting an appropriate model to construct a final machine learning prediction model.

7. The train CEM optimization method based on the machine learning according to claim 6, wherein the train crash energy absorption database is split into a training set and a test set according to a ratio of 9:1, wherein the training set is configured to train a machine learning prediction model for crash energy absorption, in other words, is configured to perform hyperparameter tuning, and the test set is retained from participating in model training and configured to evaluate a finally trained machine learning prediction model.

8. The train CEM optimization method based on the machine learning according to claim 7, wherein a hyperparameter of the machine learning prediction model is tuned by using a 10-fold cross-validation method, comprising:
in a training process, dividing the training set into ten equal subsets;
selecting each subset to validate the machine learning prediction model, and using the other nine subsets to construct the machine learning prediction model in each iteration;
training a plurality of models through a plurality of repetitions to obtain a plurality of trained models, and obtaining an average score of the plurality of trained models on a corresponding validation subset;
after finding a hyperparameter set with a highest score through grid search and cross-validation, performing training on the entire training set to construct a final prediction model; and
validating prediction performance and accuracy of a final optimal hyperparameter model by using the test set, wherein the prediction accuracy of the final optimal hyperparameter model is evaluated by using three indicators: R², mean absolute error (MAE), and root-mean-square error (RMSE).

9. The train CEM optimization method based on the machine learning according to claim 8, wherein the step 4 is as follows:
based on the concept of the CEM, taking the coupler platform force of each energy absorption interface of the train as a design variable, and taking maximum absorbed energy of the crash interface of the train nose and a minimum standard deviation between the absorbed energy of the crash interfaces of the intermediate carriage as optimization goals, to minimize a degree of damage to the train nose and ensure even distribution of crash energy;
predicting a nonlinear relationship between the design variable and the optimization goal and a constraint by using the machine learning prediction model for the train crash energy absorption, and using the nonlinear relationship obtained by the machine learning prediction model as a fitness function to establish a multi-objective optimization model for the CEM; and
performing an optimization by using a non-dominated sorting genetic algorithm-II (NSGA-II) method and combining a machine learning agent model to obtain a Pareto solution set.

10. The train CEM optimization method based on the machine learning according to claim 9, further comprising:
based on a questionnaire survey result scored by an expert, comparing impacts of different weights of the two optimization goals on an optimization result, performing comparative analysis on the optimization result and a finite element simulation result to validate accuracy of a prediction result of the machine learning agent model, and comprehensively evaluating crashworthiness of an optimized train to validate effectiveness of an energy management method.

11. The train CEM optimization method based on the machine learning according to claim 3, wherein the step 2 is as follows:
based on a concept of the CEM, making energy absorption of crash interfaces of an intermediate carriage as evenly distributed as possible while ensuring that a crash interface of a train nose absorbs more energy;
selecting a platform force of each energy absorption interface of a high-speed train as a characteristic parameter, selecting absorbed energy Eₐ of the crash interface of the train nose and a standard deviation o between absorbed energy of the crash interfaces of the intermediate carriage as labels;
conducting crash simulation analysis by using the finite element model for the eight-marshalling train crash, and generating a platform force sampling point for each energy absorption interface of the train by using an optimal Latin hypercube experimental design method; and
performing batch calculation on train crashes of an energy absorption system under different plastic platform forces by using LS-DYNA explicit dynamics software, obtaining post-processed data based on a simulation result, performing feature extraction, and establishing a train crash energy absorption database.

12. The train CEM optimization method based on the machine learning according to claim 11, wherein a data size of the train crash energy absorption database is determined by drawing a learning curve.

13. The train CEM optimization method based on the machine learning according to claim 11, wherein the step 3 is as follows:
selecting ensemble learning regression algorithms, comparing, based on a same dataset, capabilities of different algorithms in predicting the absorbed energy Eₐ and the standard deviation θ between the absorbed energy of the crash interfaces of the intermediate carriage, and selecting an appropriate model to construct a final machine learning prediction model.

14. The train CEM optimization method based on the machine learning according to claim 13, wherein the train crash energy absorption database is split into a training set and a test set according to a ratio of 9:1, wherein the training set is configured to train a machine learning prediction model for crash energy absorption, in other words, is configured to perform hyperparameter tuning, and the test set is retained from participating in model training and configured to evaluate a finally trained machine learning prediction model.

15. The train CEM optimization method based on the machine learning according to claim 14, wherein a hyperparameter of the machine learning prediction model is tuned by using a 10-fold cross-validation method, comprising:
in a training process, dividing the training set into ten equal subsets;
selecting each subset to validate the machine learning prediction model, and using the other nine subsets to construct the machine learning prediction model in each iteration;
training a plurality of models through a plurality of repetitions to obtain a plurality of trained models, and obtaining an average score of the plurality of trained models on a corresponding validation subset;
after finding a hyperparameter set with a highest score through grid search and cross-validation, performing training on the entire training set to construct a final prediction model; and
validating prediction performance and accuracy of a final optimal hyperparameter model by using the test set, wherein the prediction accuracy of the final optimal hyperparameter model is evaluated by using three indicators: R², mean absolute error (MAE), and root-mean-square error (RMSE).

16. The train CEM optimization method based on the machine learning according to claim 15, wherein the step 4 is as follows:
based on the concept of the CEM, taking the coupler platform force of each energy absorption interface of the train as a design variable, and taking maximum absorbed energy of the crash interface of the train nose and a minimum standard deviation between the absorbed energy of the crash interfaces of the intermediate carriage as optimization goals, to minimize a degree of damage to the train nose and ensure even distribution of crash energy;
predicting a nonlinear relationship between the design variable and the optimization goal and a constraint by using the machine learning prediction model for the train crash energy absorption, and using the nonlinear relationship obtained by the machine learning prediction model as a fitness function to establish a multi-objective optimization model for the CEM; and
performing an optimization by using a non-dominated sorting genetic algorithm-II (NSGA-II) method and combining a machine learning agent model to obtain a Pareto solution set.

17. The train CEM optimization method based on the machine learning according to claim 16, further comprising:
based on a questionnaire survey result scored by an expert, comparing impacts of different weights of the two optimization goals on an optimization result, performing comparative analysis on the optimization result and a finite element simulation result to validate accuracy of a prediction result of the machine learning agent model, and comprehensively evaluating crashworthiness of an optimized train to validate effectiveness of an energy management method.
